(19) United States
(12) Patent Application Publication
(10) Pub. No.: US 2011/0225344 A1
(43) Pub. Date: Sep. 15, 2011

(54) Method for Dynamic Configuration of an Electronic System with Variable Input and Output Signals

(75) Inventors: Matthew Woolsey, Nevada City, CA (US); Hauke Michael, Nevada City, CA (US)

(73) Assignee: THOMSON LICENSING S.A., F-92100 BOULOGNE-BILLANCOURT (FR)

(21) Appl. No.: 11/660,834

(22) PCT Filed: Sep. 2, 2004
(86) PCT No.: PCT/US04/28652

§ 371 Date: Jun. 1, 2011

(51) Int. Cl. G06F 12/00

(52) U.S. Cl. 711/103; 711/E12.008

(57) ABSTRACT

To enable dynamic configuration of an electronic system (10) having a first electronic module (141) and at least one second electronic module (161) for providing input and output connections to the first module, the second electronic module carries a memory (38) containing configuration information. A controller (36) on the first electronic module can query the memory (38) on an interconnected second electronic module to obtain the configuration information for that module. Using the configuration information obtained from the second electronic module, the first electronic module can configure its self accordingly. In this way, the first electronic module can configure itself without any a priori information about the second electronic module.

### TECHNICAL FIELD

This invention relates to a technique for configuring an electronic system.

### BACKGROUND ART

Many electronic systems comprise two or more interconnected circuit boards, often referred to as “modules.” A typical system can include one or more first modules each connected to one or more second modules via a coupling mechanism such as a backplane. In certain systems, each second module will have a plurality of inputs and outputs for carrying signals to and from a corresponding one of the first modules. In practice, the first and second modules reside in a frame for access through front and rear frame openings, respectively. For that reason, the first and second modules often bear the designation “front” and “rear” modules, respectively.

For static systems, that is, systems in which the structure of the rear electronic modules remains invariant, control software employed by each front electronic module for managing the interface with each rear electronic module need not worry about variations in rear electronic module input/output capability. However, for electronic systems that allow for reconfiguration by adding, deleting or replacing rear electronic modules, the front electronic module control software must have prior knowledge of all existing input and output signal combinations for each rear electronic module, as well as potential future combinations as well. Otherwise, a future reconfiguration of the system will likely require upgrading and/or replacing the control software on each front electronic module. Depending on the pace of development of rear electronic modules, frequent upgrading or replacement of the front electronic module control software could become necessary, adding to system costs.

Thus, there is a need for a technique for dynamically configuring an electronic system that does not require a priori knowledge of existing or potential future input and output configurations.

### BRIEF SUMMARY

Briefly, in accordance with a preferred embodiment of the present principles, there is provided an electronic system that comprises at least one first electronic module coupled to at least one second electronic module for providing a plurality of input and outputs for the first electronic module. Each second electronic module carries a storage device that stores information about its input and output capabilities. A controller associated with the first electronic module determines the input and output characteristics of each second electronic module by querying the storage device on that second module. In accordance with the information obtained from the storage device, the controller configures the first electronic module to support the inputs and outputs of the associated second electronic module. In this way, each first electronic module has the ability to adapt to existing or future second electronic module variations.

### BRIEF DESCRIPTION OF THE DRAWINGS

FIG. 1 depicts a top view of an electronic system in accordance with an illustrative embodiment of the present principles; and

FIG. 2 depicts in flow chart form the steps of a method of operating the electronic system of FIG. 1.

### DETAILED DESCRIPTION

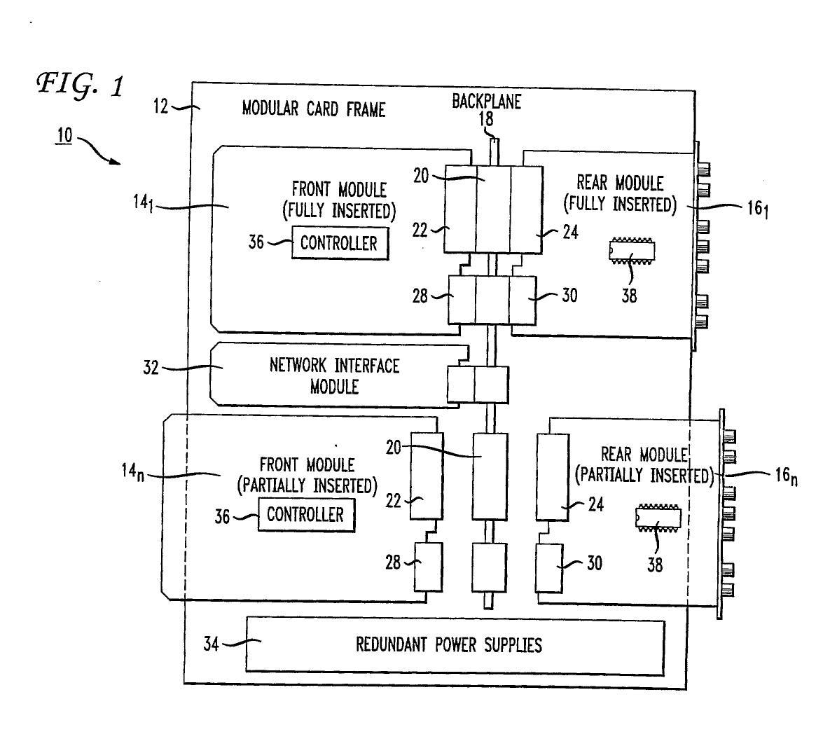

FIG. 1 depicts a plan view of an electronic system 10 in accordance with an illustrative embodiment of the present principles. The system 10 comprises a frame 12 that has at least one, and preferably, a plurality of front openings (not shown), each receiving a corresponding one of front electronic modules 14₁ . . . 14ₙ where n is an integer greater than zero. In the illustrative embodiment, n=2, although a larger or smaller number of front electronic modules could exist. Each front electronic module, such as module 14₁ takes the form of an electronic circuit board that performs one or more functions and typically supports multiple input and output configurations.

The frame 12 also includes one or more rear openings (not shown), each receiving a corresponding one of rear electronic modules 16₁-16ₘ, where m is an integer greater than zero. In the illustrative embodiment, m=2, although a larger or smaller number of rear electronic modules could exist. Each of the rear electronic modules 16₁-16ₘ takes the form of a circuit board that carries a set of input and output connectors 30 via which signals enter and leave the rear electronic module. Each rear electronic module can also carry various circuits for processing the signals received at, and supplied to the input and output connectors 30, respectively. As discussed in detail hereinafter, at least one of the rear electronic modules 16₁-16ₘ serves as an input/output bus for a corresponding one of the front electronic modules 14₁-14ₙ to carry signals to and from that front electronic module. In other words, all external connections for a given front electronic module occur through at least one associated rear electronic module. In some instances, a front electronic module will utilize multiple rear electronic modules to provide the necessary input/output connections. Moreover, a given rear module can have the capability of interfacing with a variety of front modules, not all of which will have the capability of supporting the input/output capabilities of that rear module.

An interconnection between front and rear modules can occur in several different ways. For example, a connecting mechanism, in the form of backplane 18 can provide an interconnection between one or more pairs of front and rear electronic modules 14₁-14ₙ and 16₁-16ₘ. To effect an interconnection, the backplane 18 includes a plurality of first connectors 20, each providing a through-connection between connectors 22 on and 24 on the rear and front, respectively, of a pair of opposed front and rear electronic modules, respectively, lying in the same plane. As seen in FIG. 1, when each of front and rear electronic modules 14₁ and 16₁, respectively, has been fully inserted into the frame 12 so as to lie in the same plane, the connectors 22 and 24 on the front and rear electronic modules, respectively, mate with an aligned one of the backplane connectors 20. A connection only occurs upon full insertion of the opposed pair of front and rear electronic modules into the frame 12. Thus, the front and rear electronic modules 14ₙ and ₁₆ₘ, which have only been only partially inserted in FIG. 1, do not connect with the backplane 18. In the illustrated embodiment of FIG. 1, the front and rear electronic modules 14₁-14ₙ and 16₁-16ₘ, respectively, lie in horizontally stacked arrays. Although not shown, the front and rear electronic modules 14₁-14ₙ and 16₁-16ₘ, respectively, could lie in a vertically stacked array, or in a combined both a horizontal and vertical array.

In addition to the front and rear electronic modules electronic modules 14₁-14ₙ and 16₁-16ₘ, respectively, the frame 12 can also accommodate at least one network interface module 32 and at least one power supply 34. Each network interface module 32 carries a connector for mating with a connector on the backplane. Although not shown, the power supply 34 connects to the backplane 18, which, in turn, distributes power to the front and rear electronic modules 14₁-14ₙ and 16₁-16ₘ, as well as each network interface module 32.

An interconnection between opposed front and rear modules can occur in the absence of the backplane 18. As seen in FIG. 1, the opposed front and rear modules 14ₙ and 16ₘ each carry connectors 28 and 30, respectively, configured to mate with each other through a opening (not shown) in the backplane 18 upon insertion of the front and rear modules into the frame 12. Indeed, the front and rear modules 14ₙ and 16ₘ, respectively, could interconnect with each other via their respective connectors 28 and 30 in the absence of the backplane 18. Thus, for purposes of the present principles, the backplane 18 need not exist to achieve an interconnection between front and rear modules. In this regard, a limited system could include a single front module and a single rear module, with the front module including a network interface, and the rear module including the input/output functionality and power supply capability.

In the illustrative embodiment of FIG. 1, each of the front electronic modules 14₁-14ₙ carries a controller 36 which can take the form of a microprocessor and associated memory elements, or can take the form of one or more hardware circuits comprised of one or more application specific integrated circuits (ASICs) programmable logic arrays (PLAs), such as a field programmable gate array (FPGA) or the like. The controller 36 controls the interface of its corresponding front electronic module with each of the rear electronic modules connected to that front electronic module. In a static environment, the structure of the rear electronic modules 16₁-16ₘ remains fixed. Under such conditions, the controller 36 typically possess the knowledge necessary to control the interface of its corresponding front electronic module to handle the various input signals received from each rear electronic modules, as well the various signals output by the front electronic module to each rear electronic module.

As long as the configuration of the rear electronic modules remains static, the software employed by each controller 36 need not worry about variations of the inputs and/or outputs of a given rear electronic module. However, for electronic systems that allow for reconfiguration by adding, deleting or interchanging rear electronic modules, the software employed by each controller 36 must have knowledge of all existing input and output signal combinations, as well as potential future combinations as well. In the past, the advent of new rear electronic modules necessitated the updating or replacement of the software for each controller 36, a time consuming and expensive process.

The electronic system 10 of FIG. 1 advantageously overcomes the aforementioned difficulty by providing a memory 38 on each of rear electronic modules 16₁-16ₘ. The on-board memory 38 typically takes the form of an Electrically Erasable Programmable Read-Only Memory (EEPROM), or a similar type of non-volatile memory that contains information about that rear electronic module. In particular, the memory 36 contains information related to one or more of the following attributes of the rear electronic module carrying the memory:
the number of input signals,
the number of output signals,
the type of each signal (e.g., video, audio, data etc.),
the format of each signal (SDI, Composite, AES, analog audio, etc.).
the connector types (BNC, fiber, balanced AES, etc.),
the physical layout of the connectors/signals;
any limitations regarding signals; and
any feature restrictions regarding signals.

To the extent that signal limitations exist, the memory 38 will contain information about the various modes supported for a given signal, bandwidth limitations if any, as well as data rate details, resolution data, etc. Should a given rear electronic module contain feature restrictions, the memory 38 will contain information about such restrictions. For example a given front electronic module could possess the ability to support supports 2D, adaptive 2D and adaptive 3D decoding. A particular rear electronic module might support the composite input of an associated front electronic module but limit its performance to 2D and adaptive 2D decoding, while another rear electronic module could enable additional features. From the information about feature restrictions contained in the memory 38 of a given rear electronic module, the controller 36 of an associated front electronic module can determine what feature restrictions exist for the associated rear electronic module.

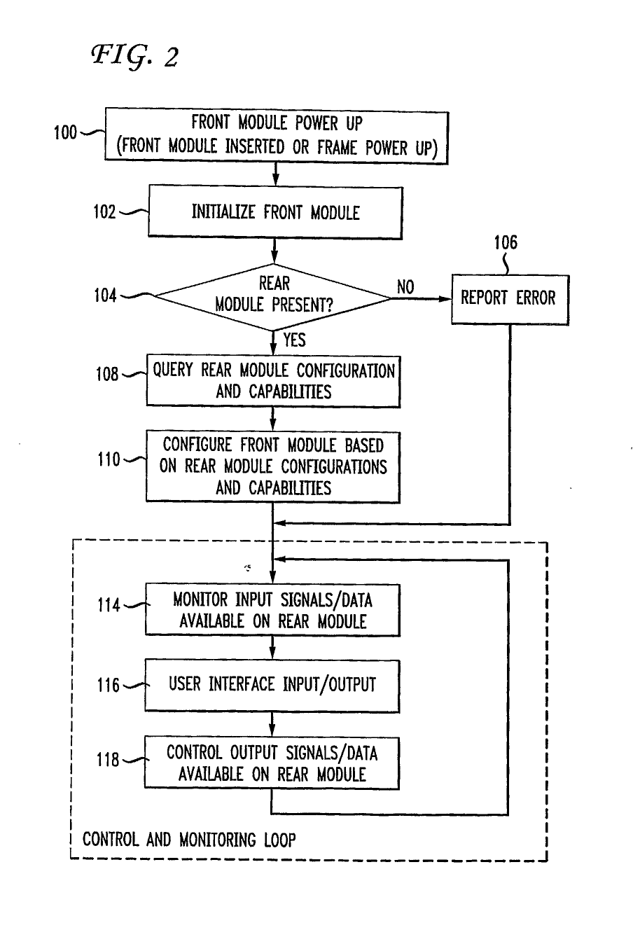

FIG. 2 depicts in flow chart the steps associated with initial power-up and operation of the electronic system 10 of FIG. 1. Initial power-up commences during step 100 of FIG. 2 upon power-up of the system 10, or if the system is presently powered, then upon insertion of a front electronic module into the frame 12. Upon being powered up, each front electronic module initializes itself during step 102. Thereafter, each front electronic module checks during step 104 whether any rear electronic modules are present, i.e., whether that front electronic module is connected to any rear electronic module. If the front electronic module finds no rear electronic module present, then that front electronic module will report an error during step 106 since every front electronic module requires a connection to at least one rear electronic module.

Assuming the presence of a rear electronic module in connection with the check made during step 104, then the front electronic module will query the memory 38 (See FIG. 1) of each associated rear electronic module during step 108. By querying the memory 38 on each rear electronic module coupled to the front electronic module, the controller 36 of FIG. 1 can establish the configuration and capability of that rear electronic module. In other words, the front electronic module can determine for a given interconnected rear electronic module the number of input signals, the number of output signals, the type of each signal, the format of each signal, the connector types, the physical layout of the connectors/signals, any limitations regarding signals; as well as any feature restrictions regarding signals. From the information obtained upon querying the memory 38 on the associated rear electronic module, the front electronic module can appropriately configure itself, typically by having the controller 36 of FIG. configure the various other elements (not shown) on the front module.

Following step 110 (or step 106 in the event of an error), the system 10 commences execution of a control and monitoring loop 112. Upon entering the control and monitoring loop 112, step 114 occurs and each front electronic module monitors input signals and/or data to obtain status information. Such monitoring will detect any change resulting from a user input occurring during step 116. During step 118, each front electronic module will respond to such user data and will control the signals and/or data available on the outputs of one or more associated rear modules in accordance with user input information.

During normal operation, each front electronic module continuously executes steps 114, 116 and 118. In contrast, steps 100-110 undergo execution on initial power up of the system 10 or in the event of the addition of a front electronic module after system power up. Although not illustrated in FIG. 2, the detection of a loss of signals, or an abnormal signal pattern during step 114, attributable to a reconfiguration of an associated rear electronic module, could trigger re-execution of steps 108 and 110.

The exact nature of the monitoring, and response that occurs will depend on the particular functionality of a given front electronic module. For example, a given front electronic module could perform encoding or decoding of video and audio streams. Thus, the monitoring, and response will relate to the encoding or decoding of video and audio streams performed by the front electronic module. Rather than perform encoding or decoding, a front electronic module could perform a video keying operation or other video processing, or even an audio processing operation. The particular functionality of the front electronic module has no particular significance with regard to its ability to configure itself based on information obtained by querying the memory 38 of an associated rear electronic module in accordance with the present principles.

The foregoing describes a technique for configuring the inputs and outputs of an electronic system.

1. An electronic system, comprising:
at least one first electronic module supporting a plurality of input and output connections;
at least one second electronic module for connection to the at least one first electronic module for providing a plurality of input and outputs thereto to at least one external device;
means for coupling the at least one first electronic module to the at least one second electronic module;
a storage device carried by the at least one second electronic module for storing input and output configuration information for the at least one second electronic module; and
a controller associated with the at least one first electronic module for querying the storage device carried by said at least one second module to gain the input and output configuration information for that second module and to configure the at least one first electronic module accordingly.

2. The electronic system according to claim 1 wherein the storage device further comprises a non-volatile memory.

3. The electronic system according to claim 2 wherein the non-volatile memory further comprises an Electrically Erasable Programmable Read-Only Memory.

4. The electronic system according to claim 1 wherein the electronic system comprises a plurality of second electronic modules, each providing a plurality of input and output connections for the at least first electronic module.

5. The electronic system according to claim 1 wherein the coupling means further comprises a backplane.

6. The electronic system according to claim 5 wherein the backplane has at least one first connector for providing a through-connection between opposed first and second electronic modules.

7. The electronic system according to claim 6 wherein the backplane further has at least one second connector for providing a connection between first and second electronic modules that do not lie opposed to each other.

8. In an electronic system having at least one rear electronic module for providing a plurality of input and outputs connection and means for coupling to the at least one rear electronic module, comprising:
at least one front electronic module supporting a plurality of input and output connections for connection via the coupling mean to the at least one rear electronic module which provides the input and output connections to the front electronic module to at least one external device;
a non-volatile storage device carried by the at least one front electronic module for storing input and output information for a plurality of rear electronic modules potentially connectable to the coupling means; and
a controller associated with the at least one front electronic module for querying the storage device carried by said at least one rear electronic module to gain the input and output configuration information for that rear electronic module and to configure the at least one front electronic module accordingly.

9. The electronic system according to claim 8 wherein the storage device further comprises a non-volatile memory.

10. The electronic system according to claim 9 wherein the non-volatile memory further comprises an Electrically Erasable Programmable Read-Only Memory.

11. A method for configuring an electronic system having at least one first electronic module supporting a plurality of input and output connections, at least one second electronic module for connection to the at least one first electronic module for providing a plurality of input and outputs to at least one external device and means for coupling the at least one first electronic module to the at least one second electronic module; the method comprising the steps of:
querying a storage device carried by said at least one first electronic module to obtain input and output configuration information for that rear electronic module;
configuring the at least one first electronic module in accordance with the input and output configuration information obtained from the storage device for said at least one second electronic module.

12. The method according to claim 11 wherein the storage device is queried to obtain a number of input signals for the at least one second electronic module.

13. The method according to claim 11 wherein the storage device is queried to obtain a number of output signals for the at least one second electronic module.

14. The method according to claim 11 wherein the storage device is queried to obtain input and output signal types for the at least one second electronic module.

15. The method according to claim 11 wherein the storage device is queried to obtain input and out signal formats for the at least one second electronic module.

16. The method according to claim 11 wherein the storage device is queried to obtain input out signal connector types for the at least one second electronic module.

17. The method according to claim 11 wherein the storage device is queried to obtain a physical layout of connectors and signals for the at least one second electronic module inputs and outputs.

18. The method according to claim 11 wherein the storage device is queried to obtain signal limitations for the at least one second electronic module.

19. The method according to claim 11 wherein the storage device is queried to obtain feature limitations for the at least one second electronic module.
